(19) United States
(12) Patent Application Publication
(10) Pub. No.: US 2005/0061932 A1
(43) Pub. Date: Mar. 24, 2005

(54) Action Stand - a.k.a. - Action Dioramas

(75) Inventor: Tederyl Robert Stallworth, Potomac Falls, VA (US)

Correspondence Address: TEDERYL R. STALLWORTH, 46172 ALSQUITH TERRACE, POTOMAC FALLS, VA, 20165, US

(73) Assignee: Mr. Tederyl Robert Stallworth, Potomac Falls, VA (US)

(21) Appl. No.: 10/710,915

(22) Filed: Aug. 12, 2004

Related U.S. Application Data
(60) Provisional application No. 60/503,575, filed on Sep. 22, 2003.

(51) Int. Cl. F16M 11/00

(52) U.S. Cl. 248/127

(57) ABSTRACT

The “Action Dioramas” configurable stands are scalable diorama display platforms for exhibiting/displaying action figures of various sizes such as available from such vendors as Hasbro, Dragon Model Limited figures and Blue Box International figures. The “Action Dioramas” configurable stands can be used individually or connected together to form a larger diorama and then augmented with various accessories to meet the user's requirements.

### DETAILED DESCRIPTION

The “Action Dioramas” configurable stand is a 8×10 inch plastic square base frame that is 1.38 inch in height and that can be configured, with accessories, to displays an outdoor/wilderness/city/battle environment. The outer walls and top of the “Action Dioramas” configurable stand is 0.08 inch thick. Configuration is done with the use of the 28 holed grid system that is incorporated on top of the Action Dioramas” configurable stand. This holed grid system has four roles of seven holes that are evenly spaced across the top to cover the stand. Each hole is 0.69 of an inch deep with a circumference of 0.19 inches. Each hole is spaced 1.38 inches apart the length of the stand and 2.38 inches apart across the width of the stand. Scalability for the “Action Dioramas” configurable stand is provided by connecting the stand s together. Each basic “Action Dioramas” configurable stand can be connected to another “Action Dioramas” configurable stand to enlarge the display area. The more “Action Dioramas” configurable stands connected together, the larger the diorama. The “Action Dioramas” configurable stand's dimensions (8×10 inches) are suitable for an individual stand to sit safely and comfortable on any bookshelf or small table. The “Action Dioramas” configurable stands are connected together by to attaching lips that are molded into the base as part of the base construction (See Drawing). There are two “one inch wide” and “0.13 inch” thick attaching lips on one of the 8 inch sides. These lips are one inch from the edge of the “Action Dioramas” configurable stand with a distance of 3.75 inch between attaching lips. On the a joining 10 inch sides, there are also two attaching lips that are one inch from the edge with a spacing of 5.63 inches between them. Thus forming an “L” shape pattern that allows attaching each “Action Dioramas” configurable stand together. The width of the attaching lips is “0.13 inch” with a thickness of 0.08 inches (See Drawing). These lips, when connected, properly provide the strength and rigidity to support figure and landscape accessories. The “Action Dioramas” configurable stands are NOT designed to be used in a free standing arrangement, but are to be placed on a flat rigid surface for support such as a table, floor, or bookshelf. To connect the “Action Dioramas” configurable stands together, all that is required of the user is to line up the individual “Action Dioramas” configurable stands and lightly press the sides together. Care must be taken to connect the individual “Action Dioramas” configurable stands to each other before adding figures or accessories. This ensures that diorama objects are not tossed and broken or during assembly. Likewise, The diorama object pieces and action figures must be removed before disconnecting the individual “Action Dioramas” configurable stands from one-another

Landscape Construction

It is envisioned that the “Action Dioramas” configurable stands shall come in several different scenic displays consisting of woodland, winter/arctic, desert, jungle and urban environments. The “Action Dioramas” can also be use with an complimenting 8½×10½-inch piece of square plastic that shall mount on top of the “Action Dioramas” base stand. This complimenting item is referred to as a “Skin”. A “Skin” shall be designed to display various land form textures (i.e., jungle, desert, street, etc.). The value in my concept is that not only may the collector easily determine the size and environment of the diorama, but may add trees, shrubs, undergrowth, rocks, buildings, building fronts, streets, etc. to fit his/her needs. The basic “Action Dioramas” configurable stand will come with a basic earth tone coloring consistent with the theme of the diorama, some undergrowth and plants will already be embedded in the stand. To embellish the diorama, various vegetation and trees can be added. Accessory mounting holes, 0.19 inch in size, are postured 1.38 inches apart length wise and 2.38 inches apart width wise in a grid formation throughout the stand to allow for trees, shrubs, etc. to be added, moved around or remove as desired. Rocks or shrubs (with a short ⅜-inch attachment) provide concealment of the holes. Trees and other vegetation may be added by merely removing the rocks and/or shrubbery and then placing the desired accessory in its place. The “Action Dioramas” configurable stand will support all 1/6 scale diorama accessories such as sandbags, boxes, wooded creates, barbwire, oil-drums, tents, sleeping bags, gas cans, buildings, etc. currently on the market.

Application

The “Action Dioramas” configurable stands are display platforms for exhibiting/displaying action figures produced by such vendors as Hasbro, Inc., Dragon Model Limited, and Blue Box International. The “Action Dioramas” configurable stands can be used individually or connected together to form a larger diorama. They can also be configured to meet the needs of the collector. The ability of the “Action Dioramas” configurable stands to be broken down into smaller components allows for easy storage, transporting, or display. Availability of a diorama accessories to support the “Action Dioramas” configurable stands are under development

1. What I claim as my invention is the “Action Diorama Configurable Stand” as describe above.
What I also claim as my invention is the “Action Dioramas” configurable stand complimenting 8½×10½-inch “Skins” (to be developed) terrain molded plastic (i.e., jungle, desert, street, etc.) that shall mount on top of the “Action Dioramas” configurable stand.
